(19) United States
(12) Patent Application Publication
(10) Pub. No.: US 2026/0119233 A1
(43) Pub. Date: Apr. 30, 2026

(54) Circuit for Accelerating Software Activation Time

(71) Applicant: Mellanox Technologies, Ltd., Yokneam (IL)

(72) Inventors: Doron Haim, Herzliya (IL); Evgeny Pimenov, Pardes Hanna Karkur (IL); Gabi Liron, Yokneam Illit (IL); Gal Barzilai, Kiriat Motzkin (IL); Hagai David, Moshav Gea (IL); Parav Pandit, Bangalore (IN); Sagi Farjun, Modiin (IL); Salvatore Di Girolamo, Zurich (CH); Sayantan Sur, Cary, NC (US); Tzur Raanan, Yokneam Ilit (IL); Uria Basher, Nehusha (IL)

(21) Appl. No.: 18/929,769

(22) Filed: Oct. 29, 2024

(51) Int. Cl. G06F 9/48; G06F 9/30

(52) U.S. Cl. CPC G06F 9/4881; G06F 9/30047; G06F 9/3009

(57) ABSTRACT

An apparatus includes one or more processor cores, a memory associated with the one or more processing cores, a scheduler, and an activation accelerator. The scheduler is to select a processor core from the one or more processor cores for executing a program thread. The activation accelerator is to send information relating to the program thread to the memory, and to notify the selected processor core to start executing the program thread using the information in the memory.

### FIELD OF THE DISCLOSURE

The present disclosure relates generally to computer systems, and specifically to offloading software activation tasks from processing cores in computer systems.

### BACKGROUND

Computer systems sometimes comprise multiple Central Processing Units (CPUs) and one or more schedulers, which are configured to allocate tasks (e.g., computer programs) for execution in one or more CPUs.

When a CPU begins running a new task, the CPU must first execute some preparatory steps. For example, the CPU may need to load task information, prefetch instructions into an instruction cache, and program a Memory Management Unit (MMU) or a Memory Protection Unit (MPU) according to the task requirements. Such preparatory tasks, sometimes referred to as Software Activation, may consume computing resources and execution time, and could degrade the performance of the computer system.

### SUMMARY

An embodiment that is described herein provides an apparatus including one or more processor cores, a memory associated with the one or more processing cores, a scheduler, and an activation accelerator. The scheduler is to select a processor core from the one or more processor cores for executing a program thread. The activation accelerator is to send information relating to the program thread to the memory, and to notify the selected processor core to start executing the program thread using the information in the memory.

In an example embodiment, the activation accelerator is to send configuration data relating to the program thread to the selected processor core, and the selected processor core is to execute the program thread using the configuration data. In another embodiment, the memory includes an instruction cache, and the activation accelerator is to send one or more instructions of the program thread to the instruction cache, for execution by the selected processor core. In yet another embodiment, the memory includes a data cache, and the activation accelerator is to send to the data cache data to be operated on by the program thread.

In a disclosed embodiment, the memory includes a tightly coupled memory (TCM), and the activation accelerator is to send to the TCM data to initialize the program thread. In still another embodiment, the apparatus further includes a Memory Management Unit (MMU), and the activation accelerator is to send configuration data to the MMU relating to the program thread. In an embodiment, the apparatus further includes a Memory Protection Unit (MPU), and the activation accelerator is to send configuration data to the MPU relating to the program thread. In a disclosed embodiment, the scheduler is to receive application data, and the activation accelerator is to send information relating to the application to the memory.

There is additionally provided, in accordance with an embodiment that is described herein, a method including selecting a processor core from among one or more processor cores for executing a program thread. Information relating to the program thread is sent to a memory associated with the one or more processing cores. The selected processor core is notified to start executing the program thread using the information in the memory.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a Computer System, configured to accelerate software activation, in accordance with an embodiment that is disclosed herein;

FIG. 2 is a block diagram that schematically illustrates a Computer System that submits Processing Threads to a plurality of Processing Cores, in accordance with an embodiment that is disclosed herein;

FIG. 3 is a block diagram that schematically illustrates a Data Flow Architecture for loading initialization and configuration data to a Processing Core, in accordance with an embodiment that is disclosed herein;

FIG. 4 is a flowchart that schematically illustrates a method for accelerating the activation time of Processing Threads in a Computer System, in accordance with an embodiment that is disclosed herein; and

FIG. 5 is a block diagram of a computing system, e.g., a data center, in accordance with an embodiment that is disclosed herein.

### DETAILED DESCRIPTION OF EMBODIMENTS

### Overview

In multi-processor computer systems, a plurality of Processing Cores may run computing tasks concurrently, wherein some of the Processing Cores run multiple concurrent threads (“Processing Threads”, also referred to as “Program Threads” hereinbelow). When a new Processing Thread is activated, the initial execution period may include a long software activation time; for example, the local Cache memory of the Processing Core typically does not contain data that the Processing Thread needs, and will experience a large number of “misses”; for another example, the Processing Core may need to load thread-specific data such as memory-protection tables, and others.

Embodiments that are disclosed herein provide methods and systems that accelerate the software activation time of Processing Threads. In embodiments, the computer system comprises an Activation Accelerator circuit, which is configured to send Thread Initialization Data to the Processing Core prior to the submission of the Processing Thread.

In disclosed embodiments, the computer system comprises one or more processor cores, a memory associated with the processing cores, a scheduler and an activation accelerator circuit. In a typical mode of operation, once the scheduler selects a processor core from the one or more processor cores for executing a program thread, the activation accelerator circuit (i) sends information relating to the program thread to the memory, and (ii) notifies the selected processor core (e.g., by sending an interrupt) to start executing the program thread using the information in the memory. In this manner, some or all of the software activation tasks are offloaded from the processor cores to the activation accelerator circuit. In various embodiments, the memory may comprise, for example, a data cache, an instruction cache, a tightly-coupled memory (TCM) and the like.

In some embodiments, the Thread Initialization Data comprises portions of the Processing Core's L1$ Instruction Cache; preloading the Instruction Cache will decrease Cache misses (and, thus, reduce cache access latency and increase performance) when the thread runs. In other embodiments, the Thread Initialization Data comprises portions of the L1$ data cache that the Processing Core may need when executing the Processing Thread; in yet other embodiments, the Thread Initialization Data comprises memory translation and/or protection tables that the Activation Accelerator loads in a memory-management/memory-protection unit that is coupled to the Processing Core.

In an embodiment, the Processing Core comprises a fast tightly coupled memory (TCM) (e.g., a Static Random-Access Memory, SRAM) that the Processing Core accesses with low latency and high throughput; the Activation Accelerator loads some or all the Thread Initialization Data to the TCM. When the Processing Core starts the execution of the Processing Thread, the Processing Core will still need to load the initialization data, but at a relatively high speed when compared to the lower speed associated with reading the data from remote memories. In some embodiments, the Activation Accelerator sends the Thread Initialization Data through one or more intermediate memories.

Thus, in embodiments, an Activation Accelerator circuit in the computer system significantly reduces the software activation time of Processing Threads and, hence, increases the performance of the computer system.

### System Description

We will describe hereinbelow circuits and methods that accelerate the software activation of Processing Threads that are allocated to Processing Cores in a multi-Processing-Core computing system.

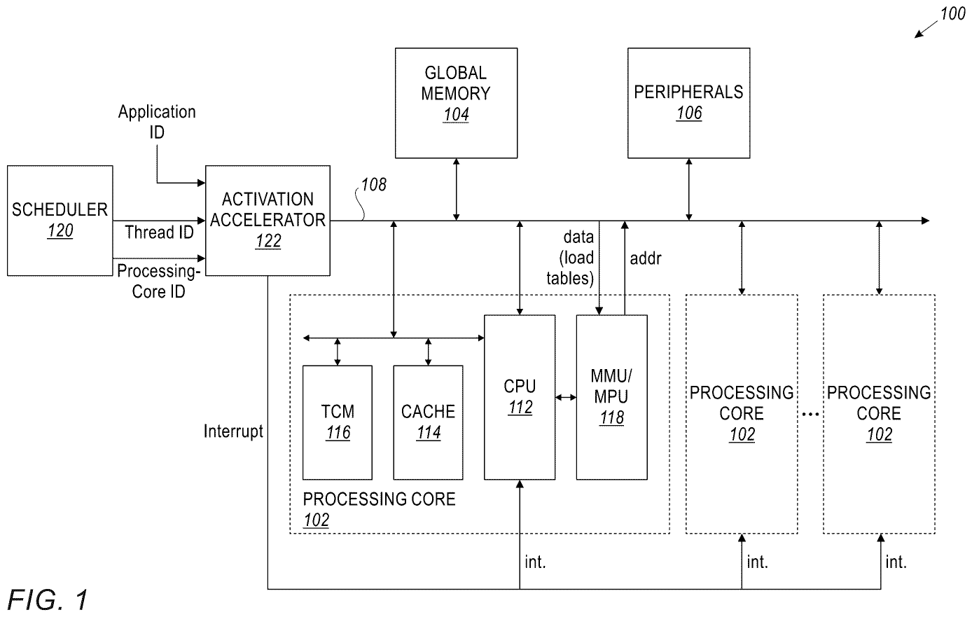

FIG. 1 is a block diagram that schematically illustrates a Computer System 100, configured to accelerate software activation, in accordance with an embodiment that is disclosed herein. Computer System 100 comprises a plurality of Processing Cores 102. Some or all the Processing Cores may facilitate multi-thread processing, wherein a plurality of Processing Threads run concurrently (typically time-sharing resources of the Processing Core).

According to the example embodiment illustrated in FIG. 1, each Processing Core 102 comprises a Central Processing Unit (CPU) 112, a Cache 114 (e.g., an instruction cache and/or a data cache), a Tightly-Coupled Memory (TCM) 116 and a Memory Management Unit 118 (in some embodiments, a Memory Protection Unit (MPU) may be used instead of, or in addition to, the MMU).

Computer System 100 further comprises a Global Memory 104 and Peripherals 106 (e.g., communication controllers), that are connected to the Processing Cores through a shared bus 108.

A Scheduler 120 is configured to dispatch Processing Threads for execution by the Processing Cores. The Scheduler selects a Processing Core to run the Processing Thread; the selected Processing Core, once activated, may need to perform some preparatory operations such as configuring the MMU/MPU and/or the peripherals, loading registers and prefetching data to the Cache prior to executing the Processing Thread (Cache fetching may be done automatically upon Cache misses rather than in a preparatory operation; however, prefetching instruction and data Cache entries typically reduces misses and improves speed).

The Scheduler sends a thread ID and a selected Processing Core ID to an Activation-Accelerator 122. In embodiments, the thread ID may include a short (e.g., 16-bit) description field that includes encoded basic Processing Thread information.

The Activation Accelerator is configured to accelerate the activation of the Processing Thread, by preloading configuration and initialization data (will be referred to as “Thread Initialization Data” below) into the dispatched Processing Core. In embodiments, the Activation Accelerator preloads instruction and/or data caches that the Processing Core may include, configure MMU/MPU address translation and/or protection tables, load CPU registers, preconfigure peripherals that the Processing Thread may access, and more, according to the thread ID and to the application (the application is typically referred to, implicitly or explicitly, by the Scheduler). When the data preload is done (or shortly before), the Activation Accelerator sends a notification (e.g., an Interrupt) to the selected Processing Core, which will then start thread execution, saving a substantial amount of data prefetch.

In other embodiments, the Activation Accelerator may send some or all of the Thread Initialization Data to TCM 116 of the selected Processing Core, which will load the data from the local memory at an improved speed.

Thus, according to the example embodiment illustrated in FIG. 1, the Activation Accelerator 122 improves the performance (in terms of throughput and latency) of the Computer System by offloading part of the software activation overhead of dispatched Processing Threads.

The configuration of Computer System 100 illustrated in FIG. 1 and described hereinabove is cited by way of example. Other configurations may be used in alternative embodiments. For example, in an embodiment, Scheduler 120 submits processes rather than Processing Threads to a selected Processing Core, and the Processing Core may break the process to Processing Threads. In other embodiments the Scheduler sends application-specific data to the selected Processing Core.

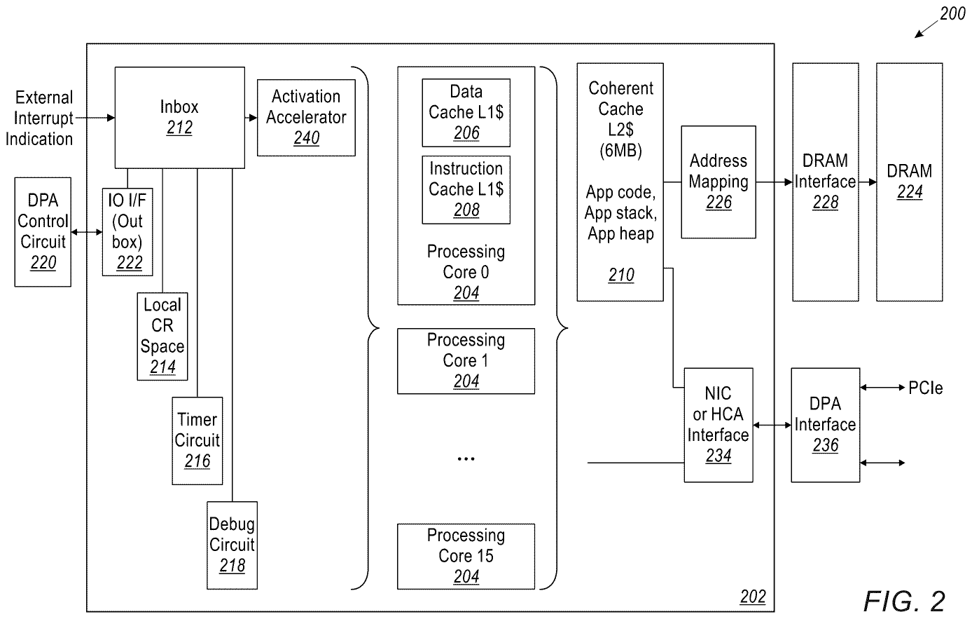

FIG. 2 is a block diagram that schematically illustrates a Computer System 200 that submits Processing Threads to a plurality of Processing Cores, in accordance with an embodiment that is disclosed herein. In some embodiments, Computer System 200 is configured to send and receive data packets over a communication network; in an embodiment, Computer System 200 comprises an NVIDIA ConnectX-7 Host Channel Adapter (HCA), or an NVIDIA ConnectX-7 Network Interface Controller (NIC).

Computer System 200 includes a Data-Processing-Architecture (DPA) core 202, which is configured to execute a plurality of computing processes concurrently. According to the example embodiment illustrated in FIG. 2, DPA 202 comprises sixteen Processing Cores 204, each Processing Core configured to run up to sixteen Hardware-Threads (HARTs) concurrently (other numbers of Processing Cores and/or HARTS per Processing Core may be used in alternative embodiments). Each Processing Core 204 comprises an L1$ Data Cache 206, and an L1$ Instruction Cache 208. Processing Cores 204 also share a relatively large (e.g., 6 MB) L2 Cache 210 for data (e.g., stack, heap etc.) and for instructions.

DPA 202 receives interrupt indications from a Real Time Operating System (RTOS), typically running on an additional Processing Core (that is not shown) and sends Interrupt indications that specify Processing Threads to be executed to an Inbox circuit 212. The Inbox Circuit Comprises an Interrupt controller that is configured to receive the interrupt indications, and a scheduler that submits Processing Threads to the Processing Cores. The examples described herein refer to interrupts, but any other suitable way of notifying the Processing Cores can be used.

DPA 202 further comprises a Local-Control-Registers (CR) Space circuit 214, comprising control registers of the DPA, a Timer Circuit 216 for measuring time periods, and a Debug circuit 218 that is configured to debug the DPA. A DPA Control Circuit 220 controls the operation of the DPA (e.g., performs congestion control, through an Input-Output Interface (Outbox) 222.

Computer System 200 further comprises a Dynamic-Random-Access Memory (DRAM) 224, which is configured to store data and instructions of the Processing Cores and of other circuits (e.g., CPUs) of the Computer System. According to the example embodiment illustrated in FIG. 2, DPA 202 communicates with the DRAM through the L2$ Cache 210, an Address Mapping Circuit 226 in the DPA that translates the Processing Cores addresses to a DRAM physical addresses space, and a DRAM Interface 228.

DPA 202 further comprises a NIC Interface (or, in embodiments, an HCA Interface) 234 that provides the Processing Core with a window for accessing the internal memories of the Computer System, that communicates, through a DPA Interface 236 that is external to the DPA, to the Computer System's Peripheral Component Interconnect Express (PCIe) bus (and/or directly), to various units of the Computer System (e.g., internal memories).

According to the example embodiment illustrated in FIG. 2, DPA 202 further comprises an Activation Accelerator 240. The Activation Accelerator is configured to send Thread Initialization Data pertaining to the dispatched Processing Thread to the selected Processing Core. For example, in some embodiments, the Thread Initialization Data comprises data to be loaded to the L1$ Data Cache 206 and/or the L1$ Instruction Cache 208 of the Processing Core 204 to which the Processing Thread is assigned. Additionally, the Thread Initialization Data that the Activation Accelerator loads may include the contents of configuration registers of a Memory Protection Unit (MPU) or a Memory Management Unit (MMU) of the Processing Core, Processing-Thread specific application data, and others. Thus, by preloading Thread Initialization Data to the selected Processing Core, the performance of the DPA can be significantly increased.

The configuration of Computer System 200, illustrated in FIG. 2 and described herein above is cited by way of example. Other configurations may be used in alternative embodiments. In some embodiments, Processing Cores 204 are not necessarily identical; in an example embodiment, some Processing Cores are optimized to execute security tasks (e.g., include encryption/decryption circuitry), while other Processing Cores are optimized for high precision calculations. In embodiments, the Computer System includes additional circuits such as fast Static Random Access Memory (SRAM), a Flash memory, and many others.

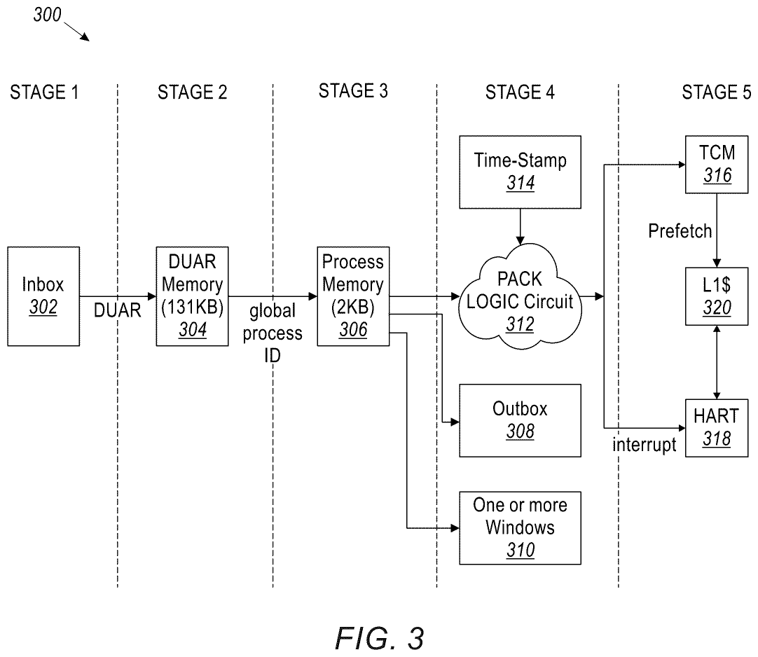

FIG. 3 is a block diagram that schematically illustrates a Data Flow Architecture 300 for loading initialization and configuration data to a Processing Core, in accordance with an embodiment that is disclosed herein. Data Flow Architecture 300 comprises five stages, in which the data propagates from the Activation Accelerator to the thread hardware (HART).

Initially, an Inbox 302 sends initialization and configuration data pertaining to the new Processing Thread (the Thread Initialization Data) over a DPA-Interrupt (DUAR) bus to a DUAR Memory 304, which stores DUAR entries. In an embodiment, DUAR memory 304 comprises 64 KB, to store the Thread Initialization Data and other information (e.g., Process-ID, Thread-in-Debug indication, and others).

The DUAR Memory sends the Thread Initialization Data and a corresponding process ID to a Process-Memory 306. In an embodiment, Process Memory 306 comprises 2 KB, and stores the Thread Initialization Data and other information (e.g., pointers, process-state bits, and others).

The Process Memory sends data to an Input-Output Interface (Outbox) 308 for interfacing with devices and memories of the Computer System, to one or more Windows 310 for interfacing with busses of the Computer Systems (e.g., a PCIe bus), and to a PACK Logic circuit 312. PACK Logic circuit 312 receives timestamps (e.g., sequential numbers) from a Time-Stamp Generator 314, packs the thread data to a suitable format and then writes the thread data into a Tightly-Coupled Memory (TCM) 316 (timestamps are added to the data). After storing the thread data in the TCM, the Pack Logic Circuit issues an Interrupt a HART 318, which is configured to the Processing Threads.

HART 318 will now add the new Processing Thread to the Processing Threads that the HART is running. An L1$ Cache (instruction and/or data) 320 is coupled to the HART and to the TCM; the Cache will prefetch instructions and data pertaining to the new Processing Thread from the TCM, and then, when the HART issues memory accesses, the L1$ Cache will load missing data and instructions from the TCM, at improved speed (in some embodiments, to reduce the latency when the HART accesses a memory address that is not stored in the Cache, the HART sends the address in parallel to the Cache and to the TCM).

The configuration of Data Flow Architecture 300 illustrated in FIG. 3 and described herein above is cited by way of example. Other configurations may be used in alternative embodiments. For example, in some embodiments, Pack Logic Circuit 312 loads some of the thread data directly to L1$ Cache 320.

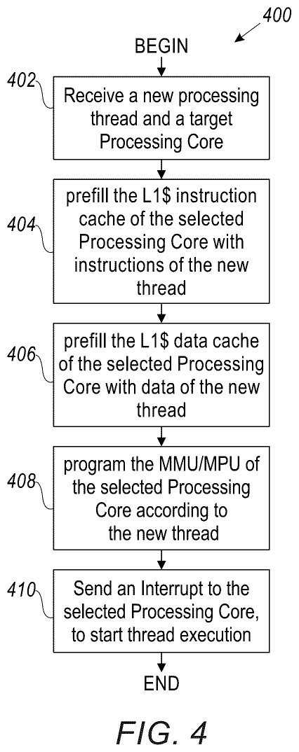

FIG. 4 is a flowchart 400 that schematically illustrates a method for accelerating the activation time of Processing Threads in a Computer System, in accordance with an embodiment that is disclosed herein. The flowchart is executed by Activation Accelerator 122 (FIG. 1).

The flowchart begins at a Receive Processing Thread operation 402, wherein the Activation Accelerator receives (e.g., from Scheduler 120, FIG. 1) a new Processing Thread ID and a designated target Processing Core. The Activation Accelerator will shorten the activation time of the new Processing Thread by preloading thread-related data. At a Prefill-Instruction-Cache operation 404, the Activation Accelerator will program L1$ Instruction Cache 208 (FIG. 2) with the preset number of instructions of the new Processing Thread. For example, in an embodiment, the Activation Accelerator will program a preset number of entries, starting from the location pointed-at by the initial Program Counter (PC) of the Processing Thread. In another embodiment, if the preset number of entries includes an unconditional branch, the Activation Accelerator will also program entries starting from the branch location, and, in yet another embodiment, if the preset number of entries includes a conditional branch, the Activation Accelerator may program entries that correspond to a true and to a false condition of the conditional branch.

Next, at a Prefill-Data-Cache operation 406, the Activation Accelerator will program L1$ Data cache 206 with data entries that the Processing Thread may read (for example, inter-thread data that the Processing Thread receives from another Processing Thread, or entries of a table that the Processing Thread may access).

The Activation Accelerator then enters a Program MMU/MPU operation 408, and programs MMU/MPU 118 (FIG. 1) according to the requirements of the new Processing Thread. For example, the Activation Accelerator may load a new virtual-to-physical translation table, and/or change a protection scheme of one or more memory segments or memory zones.

Lastly, at a Send Interrupt operation 410, the Activation Accelerator sends an Interrupt to the Processing Core, to start executing the new Processing Thread.

The configuration of flowchart 400 illustrated in FIG. 4 and described hereinabove is cited by way of example, for the sake of conceptual clarity. Other configurations may be used in alternative embodiments. For example, in some embodiments, one or two of operations 404, 406 and 408 may be skipped. In some embodiments, the Activation Accelerator may, additionally or alternatively, send application-related data to the Processing Core. In an embodiment, the Activation Accelerator sends the Thread Initialization Data to the Processing Core through intermediate memories such as DUAR memory 304, Process Memory 306 and TCM 316 (FIG. 3).

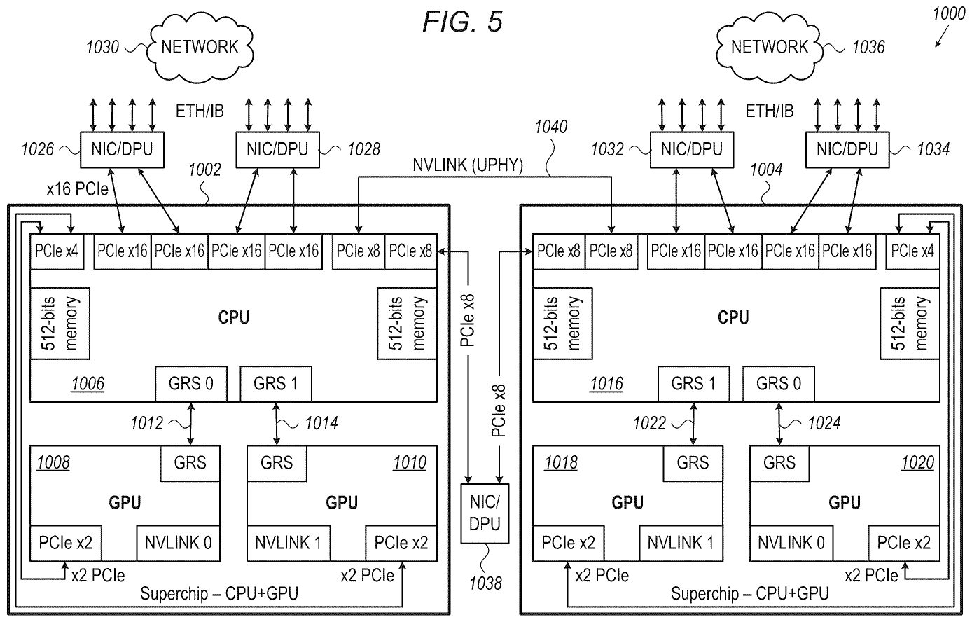

FIG. 5 is a block diagram of a computing system 1000, e.g., a data center, in accordance with an embodiment that is disclosed herein. System 1000 comprises a plurality of subsystems, e.g. multiple processing devices coupled to each other and multiple networks, according to at least one embodiment. The software activation techniques described herein can be applied in any of the processing devices of system 1000.

System 1000 is designed with multiple integrated circuits (referred to as processing devices), where each integrated circuit can include one or more CPUs and GPUs, forming a powerful and flexible architecture. These processing devices are interconnected via an NVLink or other high-speed interconnect, enabling high-speed communication between the subsystems, and are also connected through a Network Interface Card (NIC) or Data Processing Unit (DPU) to ensure efficient data transfer across the computing system 1000 and to one or more external networks 1030, 1036. The coupling of processing devices through NVLink allows for seamless data exchange and parallel processing, enhancing overall computational performance.

These processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs. An example architecture of a multi-GPU architecture is illustrated in FIG. 5.

As illustrated in FIG. 5, the computing system 1000 includes a processing device 1002 with a multi-GPU architecture. In particular, the processing device 1002 may be a system-on-chip and includes multiple subsystems such as a CPU 1006, a GPU 1008, and a GPU 1010. The CPU 1006 can be coupled to the GPU 1008 via a die-to-die (D2D) or chip-to-chip (C2C) interconnect 1012, such as a Ground-Referenced Signaling interconnect (GRS interconnect). The CPU 1006 can be coupled to the GPU 1010 via a D2D or C2C interconnect 1014. The CPU 1006 can also couple to the GPU 1008 and GPU 1010 via PCIe interconnects.

The CPU 1006 can be coupled to one or more network interface cards (NICs) or data processing units (DPUs), which are coupled to one or more networks. For example, as illustrated in FIG. 10, the CPU 1006 is coupled to a first NIC/DPU 1026, which is coupled to a network 1030. The CPU 1006 is also coupled to a second NIC/DPU 1028, which is coupled to the network 1030. The NIC/DPU 1026 and NIC/DPU 1028 can be coupled to the network 1030 over Ethernet (ETH), NVLINK or InfiniBand (IB) connections.

The computing system 1000 also includes a processing device 1004 with a multi-GPU architecture. In particular, the processing device 1004 includes multiple subsystems including a CPU 1016, a GPU 1018, and a GPU 1020. The CPU 1016 can be coupled to the GPU 1018 via an D2D or C2C interconnect 1022. The CPU 1016 can be coupled to the GPU 1020 via a D2D or C2C interconnect 1024. The CPU 1016 can also couple to the GPU 1018 and GPU 1020 via PCIe interconnects. The CPU 1016 can be coupled to one or more NICs or DPUs, which are coupled to one or more networks. For example, as illustrated in FIG. 5, the CPU 1016 is coupled to a first NIC/DPU 1032, which is coupled to a network 1036. The CPU 1016 is also coupled to a second NIC/DPU 1034, which is coupled to the network 1036. The NIC/DPU 1032 and NIC/DPU 1034 can be coupled to the network 1036 over Ethernet (ETH), NVLINK or InfiniBand (IB) connections.

In at least one embodiment, the processing device 1002 and the processing device 1004 can communication with each other via a NIC/DPU 1038, such as over PCIe interconnects. The processing device 1002 and processing device 1004 can also communicate with each other over a high-bandwidth communication interconnects 1040, such as an NVLink interconnect or other high-speed interconnects.

The configurations of Computer Systems 100, 200 and 1000, Activation Accelerator 122, Data Flow Architecture 300, and the method of flowchart 400, illustrated in FIGS. 1 through 10, are example configurations and flowcharts that are depicted purely for the sake of conceptual clarity. Any other suitable configurations and flowcharts can be used in alternative embodiments. The Computer System, Activation Accelerator, Data Flow Architecture, and components thereof may be implemented using suitable hardware, such as in one or more Application-Specific Integrated Circuits (ASIC) or Field-Programmable Gate Arrays (FPGA), using software, using hardware, or using a combination of hardware and software elements.

In some embodiments, Computer Systems 100, 200, 1000 and Data Flow Architecture 300, including components thereof, may be implemented using one or more general-purpose programmable processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof, which would occur to persons skilled in the art upon reading the foregoing description and which are not disclosed in the prior art.

1. An apparatus, comprising:
one or more processor cores;
a memory associated with the one or more processing cores;
a scheduler, to select a processor core from the one or more processor cores for executing a program thread; and
an activation accelerator, to:
send information relating to the program thread to the memory; and
notify the selected processor core to start executing the program thread using the information in the memory.

2. The apparatus according to claim 1, wherein the activation accelerator is to send configuration data relating to the program thread to the selected processor core, and wherein the selected processor core is to execute the program thread using the configuration data.

3. The apparatus according to claim 1, wherein the memory comprises an instruction cache, and wherein the activation accelerator is to send one or more instructions of the program thread to the instruction cache, for execution by the selected processor core.

4. The apparatus according to claim 1, wherein the memory comprises a data cache, and wherein the activation accelerator is to send to the data cache data to be operated on by the program thread.

5. The apparatus according to claim 1, wherein the memory comprises a tightly coupled memory (TCM), and wherein the activation accelerator is to send to the TCM data to initialize the program thread.

6. The apparatus according to claim 1, wherein the apparatus further comprises a Memory Management Unit (MMU), and wherein the activation accelerator is to send configuration data to the MMU relating to the program thread.

7. The apparatus according to claim 1, wherein the apparatus further comprises a Memory Protection Unit (MPU), and wherein the activation accelerator is to send configuration data to the MPU relating to the program thread.

8. The apparatus according to claim 1, wherein the scheduler is to receive application data, and wherein the activation accelerator is to send information relating to the application to the memory.

9. A method, comprising:
selecting a processor core from among one or more processor cores for executing a program thread;
sending information relating to the program thread to a memory associated with the one or more processing cores; and
notifying the selected processor core to start executing the program thread using the information in the memory.

10. The method according to claim 9, wherein sending the information comprises sending configuration data relating to the program thread to the selected processor core, and comprising executing the program thread, by the selected processor core, using the configuration data.

11. The method according to claim 9, wherein sending the information comprises sending one or more instructions of the program thread to an instruction cache, for execution by the selected processor core.

12. The method according to claim 9, wherein sending the information comprises sending, to a data cache, data to be operated on by the program thread.

13. The method according to claim 9, wherein sending the information comprises sending, to a tightly coupled memory (TCM), data to initialize the program thread.

14. The method according to claim 9, wherein sending the information comprises sending configuration data, relating to the program thread, to a Memory Management Unit (MMU).

15. The method according to claim 9, wherein sending the information comprises sending configuration data, relating to the program thread, to a Memory Protection Unit (MPU).

16. The method according to claim 9, wherein sending the information comprises sending application data to the memory.
